(19) United States
(12) Patent Application Publication
(10) Pub. No.: US 2025/0179226 A1
(43) Pub. Date: Jun. 5, 2025

(54) METHOD FOR PREPARING ZIEGLER-NATTA CATALYST FOR POLYMERIZATION OF LOW-DENSITY COPOLYMER

(71) Applicants: SK INNOVATION CO., LTD., Seoul (KR); SK GEO CENTRIC CO., LTD., Seoul (KR)

(72) Inventors: Jinhaek YANG, Daejeon (KR); Mun Hyung KANG, Daejeon (KR); Maengsun EO, Daejeon (KR)

(21) Appl. No.: 18/844,050

(22) PCT Filed: Apr. 20, 2023
(86) PCT No.: PCT/KR2023/005357

§ 371 Date: Sep. 5, 2024

(30) Foreign Application Priority Data
Apr. 20, 2022 (KR) 10-2022-0048735

(51) Int. Cl. C08F 210/02; C08F 4/02; C08F 4/654; C08F 4/655

(52) U.S. Cl. CPC C08F 210/02; C08F 4/022; C08F 4/6545; C08F 4/6552; C08F 2500/08; C08F 2500/12

(57) ABSTRACT

The present disclosure relates to a method for preparing a Ziegler-Natta catalyst for polymerization of a low-density copolymer, and in particular, to a method for preparing a Ziegler-Natta catalyst including preparing a magnesium chloride support using an inorganic chloride as a halogen source of the magnesium chloride support. In the method for preparing a Ziegler-Natta catalyst according to an embodiment, an inorganic chloride is used when preparing the magnesium chloride support, such that reaction conditions are mild and generation of impurities is minimized, which is preferable for large-scale preparation of catalysts.

### CROSS-REFERENCE TO RELATED APPLICATION

This application is a national stage application of PCT/KR2023/005357 filed on Apr. 20, 2023, which claims priority of Korean patent application number 10-2022-0048735 filed on Apr. 20, 2022. The disclosure of each of the foregoing applications is incorporated herein by reference in its entirety.

### BACKGROUND

### Technical Field

Embodiments of the present disclosure generally relate to a method for preparing a Ziegler-Natta catalyst for polymerization of a low-density copolymer.

### Related Art

A polymerization catalyst of the Ziegler-Natta (Z/N) type is a catalyst for producing an olefin polymer, for example, an ethylene copolymer. Typically, the Ziegler-Natta catalyst contains a magnesium compound, an aluminum compound, and a titanium compound supported on a specific support.

Since the shape and size of the polymer polymerized using the Ziegler-Natta catalyst depend on the catalyst used, it is important to prepare a catalyst that may increase productivity and may produce uniformly distributed polymers. Although a lot of development work for the preparation of the Ziegler-Natta catalyst has been carried out, some methods are amenable to large-scale preparation of catalysts because preparation conditions are significantly sensitive or a large amount of impurities or wastes are generated. Conventional art discloses a method for preparing a Ziegler-Natta catalyst in which a magnesium compound is dissolved in alcohol and then a titanium compound is added, but the preparation process is complicated and many types of materials are used.

### SUMMARY

An embodiment of the present disclosure provides a method for preparing a Ziegler-Natta catalyst for polymerization of a low-density copolymer.

Another embodiment of the present disclosure provides a method for producing a low-density copolymer comprising bringing an olefin monomer into contact with the Ziegler-Natta catalyst for polymerization of a low-density copolymer according to the embodiment.

In an embodiment, a method for preparing a Ziegler-Natta catalyst for polymerization of a low-density copolymer comprises obtaining a magnesium chloride support by reacting dialkyl magnesium with an inorganic chloride represented by the following Chemical Formula 1; and sequentially adding an alkyl aluminum chloride represented by the following Chemical Formula 2 and a metal compound containing titanium (Ti) to the magnesium chloride support to allow a reaction to proceed:

R¹ₓAlCl₃₋ₓ Chemical Formula 1
in Chemical Formula 1,
each R¹ is independently C₁₋₁₀ alkyl or C₃₋₁₀ cycloalkyl; and
x is 0 to 2,

R²_{y}AlCl_{3-y} Chemical Formula 2
in Chemical Formula 2,
each R² is independently C₁₋₁₀ alkyl or C₃₋₁₀ cycloalkyl; and
y is 1 to 2.

In another embodiment, there is provided a method for preparing a magnesium chloride support having a peak at the following diffraction angles 20 in an X-ray diffraction pattern and a δ-phase crystallinity, the method comprising reacting dialkyl magnesium m with an inorganic chloride represented by the following Chemical Formula 1:15.
0°±3.0°, 30.0°±3.0°, and 50.0°±3.0°

R¹ₓAlCl₃₋ₓ Chemical Formula 1
in Chemical Formula 1,
each R¹ is independently C₁₋₁₀ alkyl or C₃₋₁₀ cycloalkyl; and
x is 0 to 2.

In still another embodiment, a method for producing a low-density copolymer comprises bringing an olefin monomer into contact with the Ziegler-Natta catalyst for polymerization of a low-density copolymer according to the embodiment.

Embodiments of the present disclosure relate to a method for preparing for a Ziegler-Natta catalyst polymerization of a low-density copolymer, and to a method for preparing a Ziegler-Natta catalyst comprising preparing a magnesium chloride support using an inorganic chloride as a halogen source of the magnesium chloride support. In the method for preparing a Ziegler-Natta catalyst according to an embodiment, an inorganic chloride is used when preparing the magnesium chloride support, such that reaction conditions are mild and generation of impurities is minimized, which is preferable for large-scale preparation of catalysts.

### BRIEF DESCRIPTION OF DRAWINGS

Certain aspects, features, and advantages of the embodiments of the present disclosure are illustrated by the following detailed description with reference to the accompanying drawings.

FIG. 1 is a view showing XRD data of (a): conventional α-phase MgCl₂, (b): conventional δ-phase MgCl₂, and (c): MgCl₂ prepared in Example 1.

FIGS. 2 to 4 are views showing results of analyzing polymers produced using Ziegler-Natta catalysts prepared in Examples and Comparative Examples through crystallization elution fractionation (CEF).

### DETAILED DESCRIPTION

Embodiments disclosed in the present specification may be modified into various forms and the technology according to an embodiment is not limited to the embodiments described below. In addition, an implementation of an embodiment is provided to further completely describe the present invention to those skilled in the art. Furthermore, in the entire specification, unless explicitly described otherwise, “comprising” any components will be understood to imply the inclusion of other components rather than the exclusion of any other components.

A numerical range used in the present specification comprises upper and lower limits and all values within these limits, increments logically derived from a form and span of a defined range, all double limited values, and all possible combinations of the upper and lower limits in the numerical range defined in different forms. As an example, when a content of a composition is limited to 10% to 80% or 20% to 50%, a numerical range of 10% to 50% or 50% to 80% should also be interpreted as described in the present specification. Unless otherwise specifically defined in the present specification, values out of the numerical ranges that may occur due to experimental errors or rounded values also fall within the defined numerical ranges.

Hereinafter, unless otherwise specifically defined in the present specification, “about” may be considered a value within 30%, 25%, 20%, 15%, 10%, or 5% of a stated value. Hereinafter, “alkyl” in the present specification is defined as being able to mean both alkyl and cycloalkyl. In addition, even if there is no specific definition, alkyl or cycloalkyl may be construed as comprising a derivative that may be expected to exert a similar effect and may be easily modified by those skilled in the art, or alkyl or cycloalkyl substituted with a general substituent (for example, halogen or the like).

An embodiment provides a method for preparing a Ziegler-Natta catalyst for polymerization of a low-density copolymer that may implement mild reaction conditions and minimal generation of impurities.

Specifically, the method for preparing a Ziegler-Natta catalyst comprises obtaining a magnesium chloride support by reacting dialkyl magnesium with an inorganic chloride represented by the following Chemical Formula 1; and sequentially adding an alkyl aluminum chloride represented by the following Chemical Formula 2 and a metal compound containing titanium (Ti) to the magnesium chloride support to allow a reaction to proceed:

R¹ₓAlCl₃₋ₓ Chemical Formula 1
in Chemical Formula 1,
each R¹ is independently C₁₋₁₀ alkyl or C₃₋₁₀ cycloalkyl; and
x is 0 to 2,

R²_{y}AlCl_{3-y} Chemical Formula 2

### in Chemical Formula 2,

each R² is independently C₁₋₁₀ alkyl or C₃₋₁₀ cycloalkyl; and
y is 1 to 2.

In the preparation method according to an embodiment, a magnesium chloride support containing high-purity δ-phase magnesium chloride may be prepared by using an inorganic chloride as a halogen source of the support when preparing the magnesium chloride support. In addition, in a case where a low-density copolymer is polymerized using the Ziegler-Natta catalyst prepared by the preparation method described above, the low-density copolymer may be produced with a significantly increased yield and/or catalyst mileage. Since the catalyst has an excellent comonomer reactivity, a ratio of a low-density region is high compared to a copolymer prepared using a Ziegler-Natta catalyst prepared using an organic chloride and/or a commercially available low-density copolymer, such that the prepared low-density copolymer may have excellent physical properties such as a high elongation.

Moreover, in a case where an organic chloride (R—Cl (for example, t-BuCl or t-amylCl), H—Cl, or the like) is used as the halogen source of the support as in the related art, the organic chloride contains impurities, which may make it difficult to prepare a high-purity magnesium chloride support and may cause adverse effects on catalytic activity, and heating at a high temperature is required during the reaction due to a low reactivity of the organic chloride and the dialkyl magnesium, such that a desired reaction does not easily occur. In a case where the magnesium chloride support is prepared using hydrogen chloride (HCL) gas, since hydrogen chloride gas, which is a highly toxic compound, is used, large-scale preparation of the catalysts is not easy because the use of special facilities for corrosion resistance and approval for handling the compound are required.

In an embodiment, the metal compound may further contain a transition metal, and for example, may further contain a Group IV or Group V metal. Specifically, the metal compound may further contain one or more metals selected from the group consisting of Zr, Hf, V, Nb, and Ta. In this case, the metal may be contained in the form of chloride, alkoxy chloride, alkylate, or the like, but this is only an example, and the metal is not limited thereto.

In an embodiment, the metal compound containing titanium (Ti) may contain TiX₄ or (R³O)_{z}Ti(X)_{4-z}. In this case, X is a halogen atom such as I, Br, Cl, or F, each R³ is independently a linear or branched C₁₋₁₀ alkyl, C₁₋₈ alkyl, C₂₋₆ alkyl, or C₁₋₅ alkyl, and z is an integer of 1 to 4. Specific examples of the metal compound comprise TiCl₄, TiBr₄, Til₄, Ti(OBu)₄, Ti(Oi-Pr)₄, Ti(OEt)₄, Ti(OEt)₂(Cl)₂, and Ti(OEt)(Cl)₃. However, this is only an example, and the metal compound is not limited thereto.

In an embodiment, R¹'s may be each independently a linear or branched C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, or C₅₋₆ cycloalkyl, but this is only an example, and R¹ is not limited thereto.

In an embodiment, x may be 0 to 2 or 1 to 2, and specifically, may be 0, 1/2, 1, 3/2, or 2.

The inorganic chloride represented by Chemical Formula 1 may be used as a halogen source of the magnesium chloride support, and in an embodiment, the inorganic chloride may be ethyl aluminum dichloride (EtAlCl₂), methyl aluminum dichloride (MeAlCl₂), propyl aluminum dichloride (PrAlCl₂), butyl aluminum dichloride (BuAlCl₂), or ethyl aluminum sesquichloride (C₆H₁₅Al₂Cl₃, that is, (C₂H₅)_{3/2}AlCl_{3/2}), and one or more inorganic chlorides may be used simultaneously or in combination. In an embodiment, the inorganic chloride may be an alkyl aluminum monomer or dimer.

R²'s may be each independently a linear or branched C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, or C₅₋₆ cycloalkyl, but this is only an example, and R² is not limited thereto.

In an embodiment, y may be 1 to 2, and specifically, may be 1, 3/2, or 2.

In an embodiment, the alkyl aluminum chloride represented by Chemical Formula 2 may be ethyl aluminum sesquichloride (C₆H₁₅Al₂Cl₃, that is, (C₂H₅)_{3/2}AlCl_{3/2}), ethyl aluminum dichloride (EtAlCl₂), methyl aluminum dichloride (MeAlCl₂), propyl aluminum dichloride (PrAlCl₂), or butyl aluminum dichloride (BuAlCl₂), and one or more alkyl aluminum chlorides may be used simultaneously or in combination. In an embodiment, the alkyl aluminum chloride may be a monomer or dimer.

In an embodiment, the dialkyl magnesium may be substituted independently with a linear or branched C₁₋₁₀ alkyl or C₃₋₁₀ cycloalkyl. Alternatively, the dialkyl magnesium may be substituted with two substituents independently selected from C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, and C₅₋₆ cycloalkyl. In an embodiment, the dialkyl magnesium may be ethyl normal butyl magnesium (Et (n-Bu) Mg).

In an embodiment, the magnesium chloride support may have a δ-phase crystallinity. For example, the magnesium chloride support may mainly have a δ-phase crystallinity, and the δ-phase crystallinity may be 90% or more, 80% or more, 70% or more, 60% or more, or 50% or more. In an embodiment, the magnesium chloride support may be high-purity magnesium chloride mainly having a δ-phase crystallinity.

In an embodiment, the δ-phase magnesium chloride support may have a peak at the following diffraction angles 2θ in an X-ray diffraction pattern:
15.0°±3.0°, 30.0°±3.0°, and 50.0°±3.0°.

The δ-phase magnesium chloride support according to an embodiment may have a broad peak in the range of the peak value. Alternatively, the 2θ values may be, for example, 15.0°±2.0°, 32.0°±2.0°, and 50.0°±2.0° or 15.0°±1.0°, 32.0°±1.0°, and 50.0°±1.0°. The value of the diffraction angle may comprise an error value within a range of about ±0.2°.

In an embodiment, the metal compound and the alkyl aluminum chloride represented by Chemical Formula 2 may be added at a molar ratio of 1:2 to 1:10, 1:2 to 1:8, 1:3 to 1:8, 1:3 to 1:7, or 1:3.5 to 1:7. However, this is only an example, and the molar ratio is not limited thereto.

In an embodiment, the metal compound and the magnesium chloride support may react with each other at a molar ratio of 1:0.1 to 1:30, 1:5 to 1:30, 1:8 to 1:25, 1:10 to 1:25, 1:11 to 1:22, or 1:12 to 1:21. However, this is only an example, and the molar ratio is not limited thereto.

In an embodiment, a molar ratio of the dialkyl magnesium to the inorganic chloride represented by Chemical Formula 1 may be 1:1 to 1:4, 1:1 to 1:3.5, 1:1.1 to 1:3, 1:1.5 to 1:3, 1:1.1 to 1:2.5, or 1:1.5 to 1:2.5. However, this is only an example, and the molar ratio is not limited thereto.

In an embodiment, the inorganic chloride represented by Chemical Formula 1 and the alkyl aluminum chloride represented by Chemical Formula 2 may be, for example, the same compound. In an embodiment, economic feasibility and efficiency of the preparation process may be improved by using the same compound as the inorganic chloride and the alkyl aluminum chloride. Alternatively, when a low-density copolymer polymerization reaction is performed using a Ziegler-Natta catalyst prepared using the same compound as the inorganic chloride and the alkyl aluminum chloride, the yield of the polymer and the low-density region comprised in the polymer are increased, such that the physical properties of the polymer may be improved.

In an embodiment, the obtaining of the magnesium chloride support may comprise preparing a magnesium chloride slurry by slowly adding an inorganic chloride dropwise to a magnesium chloride solution at room temperature (for example, about 5° C. to 25° C., about 10° C. to 25° C., about 15° C. to 25° C., or about 18° C. to 23° C.).

In an embodiment, the obtaining of the magnesium chloride support may be an operation of obtaining a magnesium chloride support by washing a magnesium chloride slurry solution using a saturated hydrocarbon solution and then drying the magnesium chloride slurry solution, or may be an operation of obtaining a magnesium chloride support by diluting a magnesium chloride slurry solution with a saturated hydrocarbon solution, removing a supernatant, and then drying a solid.

In an embodiment, the adding of the alkyl aluminum chloride to the magnesium chloride support may comprise an operation of diluting the obtained high-purity solid magnesium chloride in a saturated hydrocarbon (for example, heptane) solution to prepare a slurry, and then adding an alkyl aluminum chloride diluted in a saturated hydrocarbon (for example, hexane) solution at room temperature (for example, about 5° C. to 25° C., about 10° C. to 25° C., about 15° C. to 25° C., or about 18° C. to 23° C.).

In an embodiment, the support prepared by the method for preparing a Ziegler-Natta catalyst for polymerization of a low-density copolymer may have a particle size of about 5 nm or less when measured based on XRD analysis (when 2θ=50°, a peak of the support (MgCl₂)). Alternatively, the particle size of the support may be 2 nm to 5 nm, 2.5 nm to 5 nm, or 3 nm to 5 nm.

Another embodiment provides a method for preparing a magnesium chloride support using an inorganic chloride, which is an operation of the method for preparing a Ziegler-Natta catalyst for polymerization of a low-density copolymer according to an embodiment.

Specifically, an embodiment provides a method for preparing a magnesium chloride support having a peak at the following diffraction angles 2θ in an X-ray diffraction pattern and a δ-phase crystallinity, the method comprising reacting dialkyl magnesium with an inorganic chloride represented by the following Chemical Formula 1:15.
0°±3.0°, 30.0°±3.0°, and 50.0°±3.0°

R¹ₓAlCl₃₋ₓ Chemical Formula 1
in Chemical Formula 1,
each R¹ is independently C₁₋₁₀ alkyl or C₃₋₁₀ cycloalkyl; and
x is 0 to 2.

In the preparation method according to an embodiment, a magnesium chloride support containing high-purity δ-phase magnesium chloride may be prepared by using an inorganic chloride as a halogen source of the support when preparing the magnesium chloride support. In addition, in a case where a low-density copolymer is polymerized using the Ziegler-Natta catalyst prepared by the preparation method described above, the low-density copolymer may be produced with a significantly increased yield and/or catalyst mileage. A ratio of a low-density region is high compared to a copolymer prepared using a Ziegler-Natta catalyst prepared using an organic chloride and/or a commercially available low-density copolymer, such that the prepared low-density copolymer may have excellent physical properties such as a high elongation.

In an embodiment, R¹'s may be each independently a linear or branched C₁₋₆ alkyl, C₁₋₅ alkyl, C₂₋₅ alkyl, —CH₃, —CH₂CH₃, —CH₂CH₂CH₃, —CH₂CH₂CH₂CH₃, C₃₋₆ cycloalkyl, C₄₋₆ cycloalkyl, or C₅₋₆ cycloalkyl, but this is only an example, and R¹ is not limited thereto.

In an embodiment, x may be 0 to 2 or 1 to 2, and specifically, may be 0, 1/2, 1, 3/2, or 2.

The inorganic chloride represented by Chemical Formula 1 may be used as a halogen source of the magnesium chloride support, and in an embodiment, the inorganic chloride may be ethyl aluminum dichloride (EtAlCl₂), methyl aluminum dichloride (MeAlCl₂), propyl aluminum dichloride (PrAlCl₂), butyl aluminum dichloride (BuAlCl₂), or ethyl aluminum sesquichloride (C₆H₁₅Al₂Cl₃, that is, (C₂H₅)_{3/2}AlCl_{3/2}), and one or more inorganic chlorides may be used simultaneously or in combination. In an embodiment, the inorganic chloride may be an alkyl aluminum monomer or dimer.

In an embodiment, the magnesium chloride support may have a δ-phase crystallinity. For example, the magnesium chloride support may mainly have a δ-phase crystallinity, and the δ-phase crystallinity may be 90% or more, 80% or more, 70% or more, 60% or more, or 50% or more. In an embodiment, the magnesium chloride support may be high-purity magnesium chloride mainly having a δ-phase crystallinity.

In an embodiment, the δ-phase magnesium chloride support may have a peak at the following diffraction angles 2θ in an X-ray diffraction pattern:
15.0°±3.0°, 30.0°±3.0°, and 50.0°±3.0°.

The δ-phase magnesium chloride support according to an embodiment may have a broad peak in the range of the peak value. Alternatively, the 2θ values may be, for example, 15.0°±2.0°, 32.0°±2.0°, and 50.0°±2.0° or 15.0°±1.0°, 32.0°±1.0°, and 50.0°±1.0°. The value of the diffraction angle may comprise an error value within a range of about ±0.2°.

Still another embodiment provides a method for producing a low-density copolymer using the Ziegler-Natta catalyst for polymerization of a low-density copolymer according to an embodiment. Specifically, there is provided a method for producing a low-density copolymer, the method comprising bringing an olefin monomer into contact with the Ziegler-Natta catalyst for polymerization of a low-density copolymer according to an embodiment.

In an embodiment, the olefin monomer may be, for example, an olefin monomer having 2 to 20, 2 to 15, or 4 to 10 carbon atoms.

In an embodiment, the low-density copolymer may be, for example, a linear low-density copolymer, and may be, for example, linear low-density polyethylene.

In an embodiment, density of the low-density copolymer may be 0.91 g/mL to 0.94 g/mL, 0.912 g/mL to 0.938 g/mL, 0.915 g/mL to 0.935 g/mL, or 0.915 g/mL to 0.924 g/mL, but this is only an example, and the density of the low-density copolymer is not limited thereto. In an embodiment, a melt index (MI) of the low-density copolymer may be 0.5 g/10 min to 5.0 g/10 min, 0.5 g/10 min to 4.0 g/10 min, 0.5 g/10 min to 3.0 g/10 min, 0.5 g/10 min to 2.5 g/10 min, 0.8 g/10 min to 2.5 g/10 min, or 1.0 g/10 min to 2.5 g/10 min, when measured at about 190° C. according to ISO 1133:1997 or ASTM D1238:1999, but this is only an example, and the melt index of the low-density copolymer is not limited thereto.

Hereinafter, Examples and Experimental Examples of the present invention will be described in detail. However, the Examples and Experimental Examples to be described below are merely illustrative of a part of the present invention, and the present invention is not limited thereto.

### Example 1

Into a 500 mL flask, 33 mL (30 mmol) of a 0.9 M ethyl normal butyl magnesium heptane solution was injected, and then 90 mL of normal heptane was injected. Then, 60 mL (60 mmol) of a 1.0 M EtAlCl₂ solution, as a chloride source of a support, was slowly added dropwise at room temperature and stirred for 30 minutes, thereby preparing a 0.2 M magnesium chloride heptane slurry solution. Thereafter, to remove a residual EtAlCl₂, the magnesium chloride slurry was filtered through a filter, washed twice with 50 mL of heptane, and then dried to recover a high-purity magnesium chloride support.

A 0.2 M slurry solution was prepared by using 0.199 g (2.10 mmol) of the recovered high-purity magnesium chloride support and heptane, 10 mL (2.00 mmol) of the slurry solution was transferred to a transparent vial, 0.50 mL (0.50 mmol) of a 1.0 M C₆H₁₅Al₂Cl₃ solution diluted in hexane, as an alkyl aluminum chloride, was injected, and stirring was performed at room temperature for 6 hours or longer. Thereafter, 1.1 mL (0.14 mmol) of 5 wt % TiCl₄, as a metal compound, was slowly added dropwise, and stirring was performed for 12 hours or longer, thereby preparing a heptane slurry solution containing a brown magnesium chloride supported catalyst (Ziegler-Natta catalyst).

### Examples 2 to 8

Heptane slurry solutions containing a brown magnesium chloride supported catalyst (Ziegler-Natta catalyst) were prepared in the same manner as that of Example 1 except that the alkyl aluminum chlorides and the metal compounds were used as shown in Table 1.

### Comparative Example 1

Into a 500 mL flask, 33 mL (30 mmol) of a 0.9 M ethyl normal butyl magnesium heptane solution was injected, and then 112 mL of normal heptane was injected. Then, stirring was performed using a magnetic stirrer. Then, 5.2 mL (6.2 g, 66 mmol) of t-BuCl, as a chloride source of a support, was slowly added dropwise for 5 minutes, and stirring was performed. Thereafter, the internal temperature of the reactor was raised to 50° C. to 60° C., and the reaction was performed for 2 hours or longer, thereby preparing a 0.2 M magnesium chloride support heptane slurry solution.

Thereafter, 9.3 mL (1.86 mmol) of the prepared 0.2 M magnesium chloride support solution was transferred to a transparent vial, 0.50 mL (0.50 mmol) of a 1.0 M C₆H₁₅Al₂Cl₃ solution diluted in hexane, as an alkyl aluminum chloride, was injected, and stirring was performed at room temperature for 6 hours or longer. Thereafter, 1.1 mL (0.14 mmol) of 5 wt % TiCl₄ was slowly added dropwise, and stirring was performed for 12 hours or longer, thereby preparing a gray-brown magnesium chloride supported catalyst (Ziegler-Natta catalyst) heptane slurry solution.

### Comparative Example 2

A gray-brown magnesium chloride supported catalyst (Ziegler-Natta catalyst) heptane slurry solution was prepared in the same manner as that of Comparative Example 1 except that the metal compound was used as shown in Table 1.

### Comparative Example 3

Into a 500 mL flask, 33 mL (30 mmol) of a 0.9 M ethyl normal butyl magnesium heptane solution was injected, and then 127 mL of normal heptane was injected. Before adding hydrogen chloride (HCl) gas, the internal temperature of the reactor was lowered to 0° C., and the stirring was performed using a magnetic stirrer. Anhydrous hydrogen chloride gas was injected at a constant rate until residual alkyl magnesium Grignard was not observed, and the reaction was terminated, thereby preparing a 0.2 M magnesium chloride support heptane slurry solution.

Thereafter, 9.3 mL (1.86 mmol) of the prepared 0.2 M magnesium chloride support solution was transferred to a transparent vial, 0.50 mL (0.50 mmol) of a 1.0 M C₆H₁₅Al₂C₁₃ solution diluted in hexane, as an alkyl aluminum chloride, was injected, and stirring was performed at room temperature for 6 hours or longer. Thereafter, 1.1 mL (0.14 mmol) of 5 wt % TiCl₄ was slowly added dropwise, and stirring was performed for 12 hours or longer, thereby preparing a brown magnesium chloride supported catalyst (Ziegler-Natta catalyst) heptane slurry solution.

### Comparative Examples 4 and 5

Brown magnesium chloride supported catalyst (Ziegler-Natta catalyst) heptane slurry solutions were prepared in the same manner as that of Comparative Example 3 except that the alkyl aluminum chlorides and the metal compounds were used as shown in Table 1.

TABLE 1

| | Chloride | Alkyl | | Magnesium |
|---|---|---|---|---|
| | source of | aluminum | Metal | chloride |
| | support | chloride | compound | support |
| Example 1 | EtAlCl₂ | A, 7.0 | C, 1.0 | 15.0 |
| | | equivalents | equivalent | equivalents |
| Example 2 | | | D, 1.0 | |
| Example 3 | | A, 3.5 | equivalent | 13.3 |
| | | equivalents | | equivalents |
| Example 4 | | A, 7.0 | | 16.6 |
| | | equivalents | | equivalents |
| Example 5 | | B, 4.0 | | 16.6 |
| | | equivalents | | equivalents |
| Example 6 | | | | 14.8 |
| | | | | equivalents |
| Example 7 | | | | 20.0 |
| | | | | equivalents |
| Example 8 | | | E, 1.0 | 15.0 |
| | | | equivalent | equivalents |
| Comparative | t-BuCl | A, 7.0 | C, 1.0 | 13.3 |
| Example 1 | | equivalents | equivalent | equivalents |
| Comparative | | | D, 1.0 | |
| Example 2 | | | equivalent | |
| Comparative | HCl (g) | | | |
| Example 3 | | | | |
| Comparative | | B, 7.0 | C, 1.0 | |
| Example 4 | | equivalents | equivalent | |
| Comparative | | | D, 1.0 | |
| Example 5 | | | equivalent | |

1) Alkyl aluminum chloride A: ethyl aluminum sesquichloride (C₆H₁₅Al₂Cl₃); B: ethyl aluminum dichloride (C₂H₅AlCl₂)

2) Metal Compound

C: TiCl₄; D: Ti(Oi-Pr)₄; E: TiCl₄+VOCl₃

### <Experimental Example 1> X-Ray Diffraction (XRD) Analysis

XRD analysis was performed under the following equipment and analysis conditions to obtain an XRD spectrum of the magnesium chloride support prepared in Example 1.

Maker: PANalytical; Anode material: Cu; K-Alpha1 wavelength: 1.540598; Generator voltage: 40 kV; Tube current: 30 mA; Scan Range: 20 to 60; Scan Step Size: 0.026; Divergence slit: 1/4°; Antiscatter slit: 1/2°; Time per step: 100 s

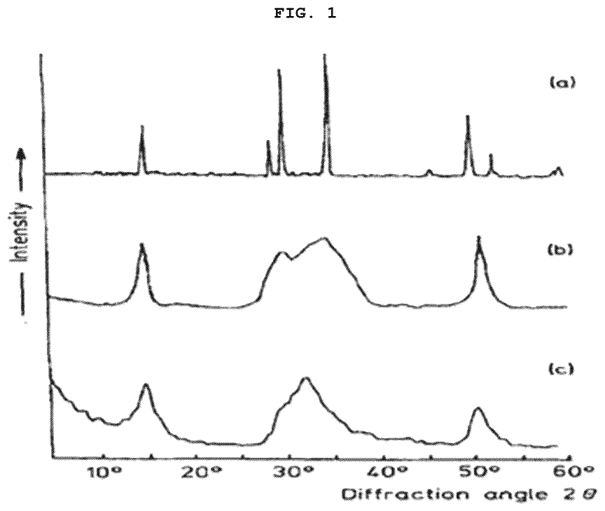

As a result, referring to FIG. 1, (a) was the conventional α-phase MgCl₂, (b) was the conventional δ-phase MgCl₂, (c) was the δ-phase MgCl₂ prepared in Example 1, and broad peaks were observed at diffraction angles (20) of about 15°, 30°, and 50°.

### <Experimental Example 2> Polymerization of Low-Density Copolymer

An autoclave reactor was filled with 0.5 L of a saturated hydrocarbon solvent in a stable anhydrous nitrogen state, 0.2 g (0.15 mol) of triethyl aluminum and 100 mL (70 g, 0.7 mol) of 1-octene were injected, the temperature of the reactor was raised to 180° C., stirring was performed, and then ethylene was injected into the reactor at 30 bar. The catalysts (1.7 μmol) in the slurry solution state prepared in Examples 1 to 8 and Comparative Examples 1 to 8 were diluted with a saturated hydrocarbon solvent (methylcyclohexane) (3 mL), each of the catalysts (1.7 μmol) diluted with the saturated hydrocarbon solvent (3 mL) was transferred to a catalyst port, and the catalyst port was pressurized with anhydrous nitrogen (50 bar). After the inside of the autoclave reactor was saturated with ethylene, the catalyst was injected from the catalyst port into the reactor under an isothermal condition of 180° C., and semi-batch polymerization with a continuous supply of ethylene was performed for 10 minutes. Thereafter, the reactant was recovered through an outlet and the solvent was dried to obtain a low-density copolymer (linear low-density polyethylene (LLDPE)). The yield, catalyst mileage, melt index, and density of the obtained low-density copolymer were measured. The results thereof are shown in Table 2.

At this time, the catalyst mileage was defined as a value obtained by dividing the mass of the produced LLDPE by the mass of the catalyst. The melt index was measured by conducting a test at 190° C. according to the ASTM D1238 standard, and the density was measured with a density gradient column.

TABLE 2

| | LLDPE | Catalyst mileage | MI | Density |
|---|---|---|---|---|
| | yield (g) | (LLDPE ton/catalyst kg) | (g/10 min) | (g/mL) |
| Example 1 | 12.10 | 2.94 | 1.09 | 0.92 |
| Example 2 | 12.40 | 3.01 | 1.20 | 0.92 |
| Example 3 | 11.93 | 3.84 | 0.87 | 0.92 |
| Example 4 | 12.83 | 2.93 | 1.08 | 0.92 |
| Example 5 | 13.63 | 3.65 | 0.91 | 0.92 |
| Example 6 | 12.77 | 3.70 | 0.71 | 0.92 |
| Example 7 | 19.33 | 4.52 | 2.16 | 0.92 |
| Example 8 | 15.00 | 4.31 | 1.00 | 0.92 |
| Comparative | 7.30 | 1.90 | 0.77 | 0.92 |
| Example 1 | | | | |
| Comparative | 9.03 | 2.35 | 0.82 | 0.92 |
| Example 2 | | | | |
| Comparative | 6.40 | 1.66 | 1.00 | 0.92 |
| Example 3 | | | | |
| Comparative | 9.87 | 2.56 | 2.50 | 0.92 |
| Example 4 | | | | |
| Comparative | 12.60 | 3.27 | 1.01 | 0.92 |
| Example 5 | | | | |

Referring to Table 2, the yield of the copolymer is significantly increased when the polymerization is performed using the catalysts prepared in Examples, compared to the case where the polymerization is performed using the catalysts for polymerization of a low-density copolymer prepared in Comparative Examples.

### <Experimental Example 3> Crystallization Elution Fractionation (CEE)

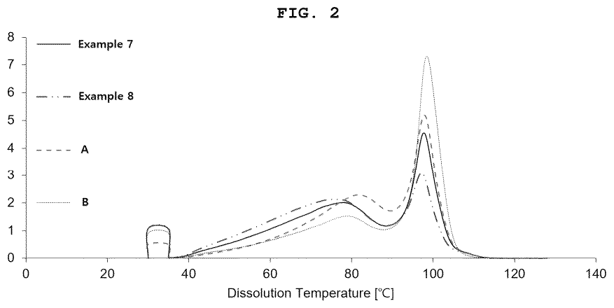

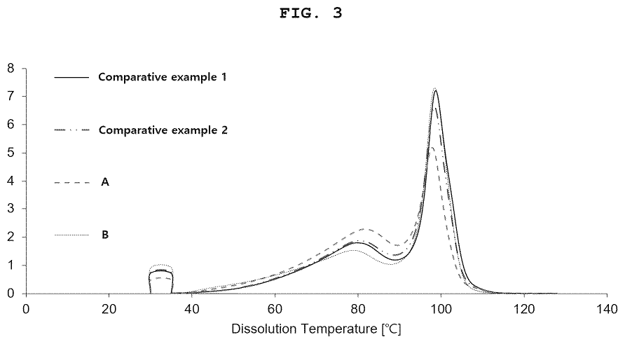

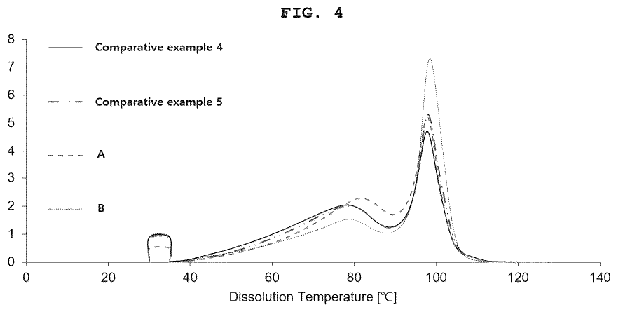

To analyze the physical properties of the polymers prepared using the catalysts of Examples and Comparative Examples through crystallization elution fractionation (CEF), a test was conducted using POLYMER-CHAR CRYTEX-42 instrument and a trichlorobenzene (TCB) solution. At this time, commercial product A (Dow Chemical Company) and commercial product B (SK Chemicals Co., Ltd.) were prepared and tested as comparative groups. The results thereof are illustrated in FIGS. 2 to 4.

Through the above experiments, it could be confirmed that, in the cases of the polymers prepared using the catalysts of Examples, the ratio of the high-density region (homopolymer) at about 90° C. to 100° C. was low and the ratio of the low density region (copolymer) at about 50° C. to 90° C. was high in the CEF spectrum compared to the commercial products. Therefore, a low-density copolymer having a high elongation may be effectively prepared using the catalysts of Examples.

Hereinabove, the present invention has been described in detail through preferred Examples and Experimental Examples of various embodiments, but the scope of the embodiments of the present invention is not limited to a specific Example, and should be interpreted according to the appended claims. In addition, those skilled in the art should understand that various modifications and alternations are possible without departing from the scope of the present invention. Furthermore, the embodiments may be combined to form additional embodiments.

1. A method for preparing a Ziegler-Natta catalyst for polymerization of a low-density copolymer, the method comprising:
obtaining a magnesium chloride support by reacting dialkyl magnesium with an inorganic chloride represented by the following Chemical Formula 1; and
sequentially adding an alkyl aluminum chloride represented by the following Chemical Formula 2 and a metal compound containing titanium (Ti) to the magnesium chloride support to allow a reaction to proceed:
R¹ₓAlCl₃₋ₓ Chemical Formula 1
in Chemical Formula 1,
each R¹ is independently C₁₋₁₀ alkyl or C₃₋₁₀ cycloalkyl; and
x is 0 to 2,
R²_{y}AlCl_{3-y} Chemical Formula 2
in Chemical Formula 2,
each R² is independently C₁₋₁₀ alkyl or C₃₋₁₀ cycloalkyl; and
y is 1 to 2.

2. The method of claim 1, wherein the metal compound further contains a Group IV or Group V metal.

3. The method of claim 1, wherein the metal compound further contains one or more metals selected from the group consisting of Zr, Hf, V, Nb, and Ta.

4. The method of claim 1, wherein each R¹ is independently C₁₋₆ alkyl or C₃₋₆ cycloalkyl, and
x is 1 to 2.

5. The method of claim 1, wherein each R₂ is independently C₁₋₆ alkyl or C₃₋₆ cycloalkyl, and
y is 1 to 2.

6. The method of claim 1, wherein the magnesium chloride support has a peak at the following diffraction angles 2θ in an X-ray diffraction pattern and a δ-phase crystallinity,
15.0°±3.0°, 30.0°±3.0°, and 50.0°±3.0°.

7. The method of claim 1, wherein the metal compound and the alkyl aluminum chloride represented by Chemical Formula 2 are added at a molar ratio of 1:2 to 1:10.

8. The method of claim 1, wherein the metal compound and the magnesium chloride support react with each other at a molar ratio of 1:0.1 to 1:30.

9. The method of claim 1, wherein the inorganic chloride represented by Chemical Formula 1 and the alkyl aluminum chloride represented by Chemical Formula 2 are the same compound.

10. The method of claim 1, wherein the metal compound contains TiX₄ or (R³O)_{z}Ti(X)_{4-z} where X is a halogen atom, each R³ is independently C₁₋₁₀ alkyl, and z is an integer of 1 to 4.

11. The method of claim 1, wherein the inorganic chloride represented by Chemical Formula 1 and the alkyl aluminum chloride represented by Chemical Formula 2 are each independently EtAlCl₂, MeAlCl₂, PrAlCl₂, BuAlCl₂, or (C₂H₅)_{3/2}AlCl_{3/2}.

12. A method for preparing a magnesium chloride support having a peak at the following diffraction angles 2θ in an X-ray diffraction pattern and a δ-phase crystallinity, the method comprising reacting dialkyl magnesium with an inorganic chloride represented by the following Chemical Formula 1:
15.0°±3.0°, 30.0°±3.0°, and 50.0°±3.0°
R¹ₓAlCl₃₋ₓ Chemical Formula 1
in Chemical Formula 1,
each R¹ is independently C₁₋₁₀ alkyl or C₃₋₁₀ cycloalkyl; and
x is 0 to 2.

13. A method for producing a low-density copolymer, comprising bringing an olefin monomer into contact with the Ziegler-Natta catalyst for polymerization of a low-density copolymer prepared by the method for preparing a Ziegler-Natta catalyst for polymerization of a low-density copolymer of claim 1.

14. The method of claim 13, wherein a density of the low-density copolymer is 0.91 g/mL to 0.94 g/mL, and a melt index (MI) of the low-density copolymer is 0.5 g/10 min to 5.0 g/10 min when measured according to ASTM D1238.
